(19) United States
(12) Patent Application Publication
(10) Pub. No.: US 2004/0031885 A1
(43) Pub. Date: Feb. 19, 2004

(54) IN ORBIT SPACE TRANSPORTATION & RECOVERY SYSTEM

(76) Inventors: Robert F. D'Ausilio, Bountiful, UT (US); Roger X. Lenard, Edgewood, NM (US); Bari M. Southard, Bountiful, UT (US)

Correspondence Address: Giaccherini, Post Office Box 1146, Carmel Valley, CA, 93924, US

(21) Appl. No.: 10/298,138

(22) Filed: Nov. 15, 2002

Related U.S. Application Data
(63) Continuation-in-part of application No. 09/918,705, filed on Jul. 30, 2001, now abandoned.

(51) Int. Cl. B64G 1/62

(52) U.S. Cl. 244/172

(57) ABSTRACT

An In Orbit Transportation & Recovery System (IOSTAR™) (10) is disclosed. One preferred embodiment of the present invention comprises a space tug powered by a nuclear reactor (19). The IOSTAR™ includes a collapsible boom (11) connected at one end to a propellant tank (13) which stores fuel for an electric propulsion system (12). This end of the boom (11) is equipped with docking hardware (14) that is able to grasp and hold a satellite (15) and as a means to refill the tank (13). Radiator panels (16) mounted on the boom (11) dissipate heat from the reactor (19). A radiation shield (20) is situated next to the reactor (19) to protect the satellite payload (15) at the far end of the boom (11). The IOSTAR™ (10) will be capable of accomplishing rendezvous and docking maneuvers which will enable it to move spacecraft between a low Earth parking orbit and positions in higher orbits or to other locations in our Solar System.

### CROSS-REFERENCE TO A RELATED PENDING U.S. PATENT APPLICATION & CLAIM FOR PRIORITY

The present patent application is a Non-Provisional, Continuation-in-Part patent application. The Applicant claims the benefit of priority under Sections 119 & 120 for any subject matter which is commonly disclosed in pending parent application, U.S. Ser. No. 09/918,705, filed on Jul. 30, 2001, and the present application.

### FIELD OF THE INVENTION

The present invention relates to the field of spacecraft and satellites. More particularly, this invention provides a transportation and rescue system for moving objects in space between low Earth orbits, higher orbits and beyond.

### FEDERALLY SPONSORED RESEARCH OR DEVELOPMENT

None.

### BACKGROUND OF THE INVENTION

Hundreds of man-made satellites are currently in orbit around the Earth. Over the next decade, governments and companies around the globe plan to launch hundreds of new spacecraft for a variety of communications, defense and remote sensing projects. The placement of satellites into Earth orbit can cost many millions of dollars. A conventional launch involves a large multi-stage, single-use rocket to lift a satellite into a geosynchronous orbit.

A general description of conventional nuclear-propulsion systems may be found in a text entitled A Critical Review of Space Nuclear Power and Propulsion, edited by Mohamed S. El-Genk, which was published by the American Institute of Physics in 1994.

The U.S. Departments of Energy and Defense and NASA developed plans for a Generic Flight System for space-based defense systems and NASA exploration missions called SP-100 in the mid-1980's. The SP-100 was designed to supply nuclear-power for military and civilian space systems. This early system was designed as a single-use power stage for a single, permanently attached payload; and was never configured for any on-orbit rendezvous, docking or servicing missions. The SP-100 is described in the SP-100 Technical Summary Report, which was prepared for the U.S. Department of Energy by the Jet Propulsion Laboratory and the California Institute of Technology in September, 1994.

Various nuclear electric propulsion systems are described in a publication entitled Nuclear Electric Propulsion, A Summary of Concepts Submitted to the NASA/DoE/DoD Nuclear Electric Propulsion Workshop, which was held in Pasadena, Calif. on Jun. 19-22, 1990.

The Aerospace Division of the Olin Corporation proposed a small engine for the small satellite community called the Small Upper Stage (SUS). The SUS was designed to accomplish low Earth orbit transfers, orbit circularizations and plane changes using hydrazine propulsion.

TRW has patented several methods and apparatus intended for the space transportation market. In U.S. Pat. No. 4,471,926, Steel describes a Transfer Vehicle for Use in Conjunction with a Reusable Space Shuttle. This spacecraft has a propulsion system that uses a low-thrust bi-propellant liquid rocket engine to provide a soft, low-acceleration ascent. In U.S. Pat. No. 4,575,029, Harwood and Love disclose a spacecraft for transporting a payload from a space shuttle in a low altitude parking orbit to an operational orbit. In U.S. Pat. No. 4,943,014, Harwood and Love reveal their “soft ride” method for changing the altitude or position of a spacecraft in orbit using a liquid bi-propellant engine.

In U.S. Pat. No. 4,664,344, Harwell describes an apparatus and method of capturing an orbiting spacecraft. This device comprises a relatively small mechanical probe and fixture operated by an astronaut during a spacewalk.

In an article entitled Topaz Two Proves to Be a Gem for International Tech Transfer, contained in Technical Applications Report from Ballistic Missile Defense Organization, 1995, thermoionic reactors for space-based power generation are disclosed.

Prospects for Nuclear Electric Propulsion Using Closed-Cycle Magnetohydrodynamic Energy Conversion, by R. Litchford et al. was presented at the 12^{th} Annual Advanced Space Propulsion Workshop in Huntsville, Ala. on Apr. 3-5, 2001.

J. Collins et al. disclose a Small Orbit Transfer Vehicle for On-Orbit Servicing and Resupply which was presented at the 15^{th} Annual Utah State University Conference on Small Satellites at Logan, Utah, Aug. 13-16, 2001.

The development of an in-orbit space transportation and rescue vehicle would dramatically reduce the cost of changing the orbital position of a satellite. Such a system would revolutionize the military and commercial space industries, and fill a long-felt need in the telecommunications, direct-broadcast and remote-sensing industries.

### SUMMARY OF THE INVENTION

The In Orbit Space Transportation & Recovery System (IOSTAR™) will revolutionize the commercial space industry by providing a lower cost alternative to conventional methods of moving spacecraft in orbit. Instead of using a multi-stage rocket powered by expensive and dangerous chemical fuels to lift a payload to a geosynchronous or geostationary orbit, the IOSTAR™ will rendezvous with a satellite waiting in a low Earth orbit, dock with the satellite and then gently transport it to an altitude of 23,300 miles using reliable nuclear-powered electric propulsion. The IOSTAR™ will also be available to relocate, rescue and/or retrieve satellites in need of repositioning or repair, and will be capable of ferrying objects to the Moon and to the neighboring planets of our Solar System.

One embodiment of the IOSTAR™ includes a collapsible boom which may double as a radiating surface, and which expands to its fully extended position after reaching orbit. The boom is connected at one end to a tank which stores xenon which fuels ion propulsion engines located at the opposite end of the boom. Docking hardware which is capable of engaging a wide variety of objects in space is coupled to the farthest end of the boom near the fuel tank. A nuclear reactor, a radiation shield, an energy converter and a large array of heat-dissipating flat-panel radiators are mounted on the boom between the reactor and a payload grasping device.

An appreciation of the other aims and objectives of the present invention and a more complete and comprehensive understanding of this invention may be obtained by studying the following description of a preferred embodiment and by referring to the accompanying drawings.

### A BRIEF DESCRIPTION OF THE DRAWINGS

FIGS. 1A & 1B present top and end views of one of the preferred embodiments of the In Orbit Space Transportation & Recovery (IOSTAR™) vehicle in its fully deployed, orbital configuration.

FIG. 2 depicts a separate service and refueling vehicle.

FIG. 3 is a side view of the present invention in its fully deployed configuration.

FIG. 4 reveals the present invention in a folded and collapsed configuration that may be loaded aboard a launch vehicle.

FIGS. 5, 6, 7 and 8 present side and end views of preferred embodiments of the present invention stowed aboard a launch vehicle.

FIG. 9 is a block diagram of control systems installed in the IOSTAR™ spacecraft.

FIG. 10 is a cross-sectional view of an ion propulsion engine utilized by one embodiment of the IOSTAR™ spacecraft.

FIG. 11 is a cross-sectional view of a portion of one embodiment of the invention.

FIG. 12 presents a diagram which provides an overview of the Brayton System, which is used as the energy converter in one embodiment of the invention.

FIG. 13 supplies a perspective view of an alternative embodiment of the IOSTAR™.

FIG. 14 is a schematic depiction of the process of conveying a satellite from a low Earth orbit to a higher orbit using the present invention.

FIG. 15 illustrates a method for repositioning a satellite.

FIGS. 16 and 17 are comparisons of high orbit architectures for conventional and IOSTAR™ missions.

FIGS. 18, 19, 20 and 21 exhibit four IOSTAR™ missions.

FIGS. 22 and 23 show the IOSTAR™ and the International Space Station.

### A DETAILED DESCRIPTION OF PREFERRED & ALTERNATIVE EMBODIMENTS

I. Overview of Embodiments of IOSTAR™

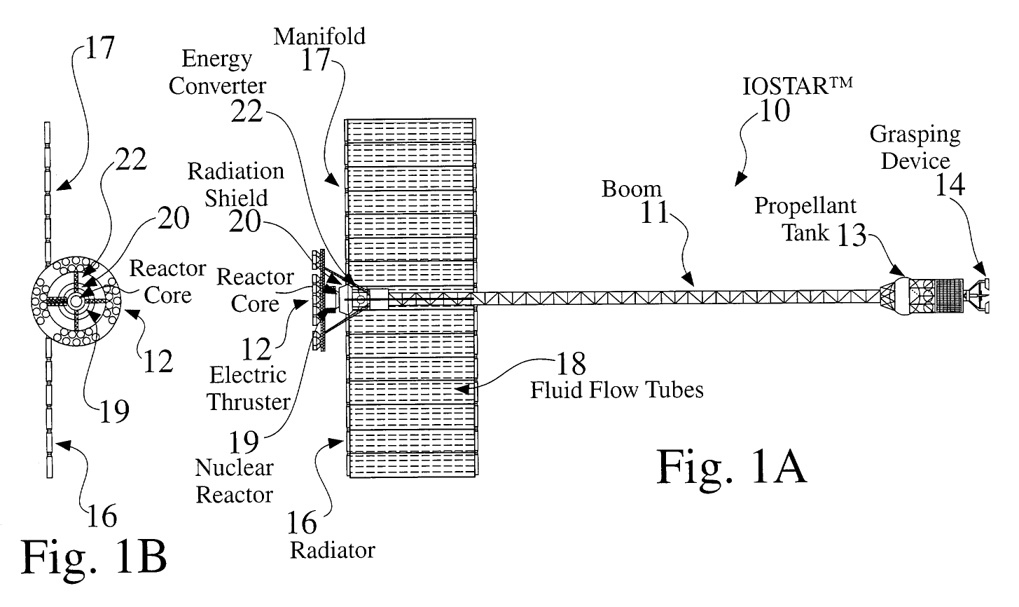

FIGS. 1A and 1B reveal side and end views of one of the preferred embodiments of the In Orbit Transportation & Recovery System, or IOSTAR™ 10. IOSTAR™ is a Trade and Service Mark owned by the Assignee. IOSTAR™ is a reusable spacecraft 10 which is designed primarily for orbital transportation and rescue services.

In this Specification and in the claims that follow, the term “satellite” refers to any object in orbit, whether natural or man-made. The term “spacecraft” concerns any device or means used at high altitude or beyond the Earth's atmosphere, or for travel in space; including a ship, structure, machine or manufacture that may travel beyond Earth's orbit. The term “orbit” generally means a pathway or line of movement of an object that includes any position at any point or altitude above the surface of the Earth or other celestial body which allows an object, satellite or spacecraft to move above the Earth's surface with or without aerodynamic lift, up to a distance which is still within the Earth's gravitational field.

In general, the term “low Earth orbit” encompasses any orbital altitude below geosynchronous or geostationary orbit. In general, the term “high Earth orbit” encompasses any orbital altitude from geosynchronous or geostationary orbit to any position within the Earth's gravitational field. In general, the term “space” refers to any position generally outside the Earth's atmosphere. The term “object” pertains to any configuration, embodiment or manifestation physical mass or matter, including natural objects such as asteroids or MMOD's (micro-meteoroids and orbital debris), man-made devices, or other things or items.

In one embodiment of the invention, the backbone or central skeleton of the IOSTAR™ 10 comprises a lightweight but strong, generally metallic or composite, collapsible, compressible or at least partially foldable boom 11. The boom 11 provides structural support, but is also capable of fitting inside a launch vehicle when collapsed, and then extending to its fully deployed length after launch. The launch vehicle may be a single use vehicle, or may be reusable or expendable. In a preferred embodiment of the invention, the IOSTAR™ will be lifted into orbit by the United States Space Shuttle.

In one embodiment, one end of the boom 11 is connected to an electric propulsion system 12. In general, an electric propulsion system is any means which employs electromagnetic forces to generate thrust. In one embodiment, a tank 13 which stores propellant for the electric propulsion system 12 is connected to the boom 11 at the end opposite from the ion engines 12. In a preferred embodiment of the invention, the electric propulsion system is an ion propulsion system 12 which expels ions to produce thrust. Table One contains a list of some of the various types of electric propulsion systems that may be utilized to implement the present invention.

TABLE ONE
Electric Propulsion Alternatives.

Electrothermal
Arcjets
Resistojets
Electrothermal thruster
Continuous wave
Laser & Laser Ablative
Microwave heated thruster
Electromagnetic
Magnetoplasmadynamic thruster
Self-Field
Applied Field
Hall effect thruster
Stationary plasma thruster
θ-pinch thruster
Compact toroid thruster
Pulsed-inductive thruster
Coil-gun
Z-pinch discharge thruster
Coax gun
Pulsed-plasma thruster
Rail-gun
Mass-driver
Electrostatic
Ion engine
Field emission
Other
Magnetic loop sail
Electrodynamic Tether

The recitation of electric propulsion alternatives in Table One is not intended to exclude any unlisted or equivalent alternatives.

In a preferred embodiment of the invention, the ion engines 12 employ xenon ions, so the tank is filled with xenon. In an alternative embodiment, the ion propulsion system 12 includes a Hall thruster. Other embodiments of the invention may employ different fuels, and may utilize multiple fuels. The invention may utilize any tank means which holds, envelopes or stores suitable propellants.

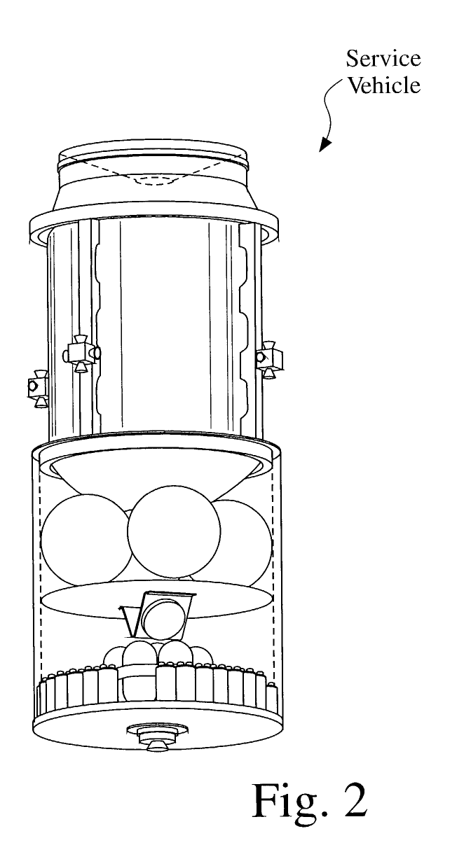

In a preferred embodiment of the invention, the tank 13 is refillable, and may be refilled in a relatively low or zero gravity environment. One embodiment of the invention includes one or more tanks that provides the propulsion system with propellant. In one embodiment of the invention, the tank may be refilled by a separate, automatic, unmanned spacecraft as shown in FIG. 2. When the IOSTAR™ vehicle runs low on propellant, it will be replenished by a servicing vehicle that either transfers all its propellant and is then released; or transfers its propellant gradually and is released when empty. In one embodiment, the IOSTAR™ will have a lower pressure tank so that pumping is kept to a minimum or eliminated. In another alternative, the size of the lower pressure tank is smaller, and includes limited life thrusters attached to the servicing vehicle. The electric thrusters on the service vehicle can be operated at higher power than the rest of the thrusters on the IOSTAR™ to enhance performance since the high power reduces lifetime, the thrusters are replaced with the next service vehicle. The thrusters may have a limited lifetime, and be used for a relatively small number of missions, or, may last for the entire lifetime of the IOSTAR™. The service vehicle may be equipped with application specific thrusters that are replaced with the next service vehicle.

Table Two contains a list of some of the propellants that may be employed to practice the present invention.

TABLE TWO
Propellants

Xenon
Mercury
Aluminum
Bismuth
Krypton
Helium
Argon
Production Kr—Xe mix
Hydrogen
Nitrogen
N₂ + 2H₂
NH₃
H₂O
NH₃
CO₂
N₂H₄
CH₄
Air
Lithium
Cesium
Indium
Teflon

The recitation of propellant alternatives in Table Two is not intended to exclude any unlisted or equivalent alternatives.

The end of the boom 11 which holds the propellant tank 13 is equipped with reusable docking hardware 14 that is able to contact or grasp a satellite 15 or some other object in space. This docking hardware 14 may be referred to as a grasping device, and may comprise any multiple-use means for engaging an object above the Earth. Many different embodiments of the docking hardware 14 may be incorporated in the present invention. In general, the preferred embodiment of the invention is reusable, utilizes a multiple-use docking device 14, which, unlike some of the prior art, is designed for many missions over a relatively long life-time.

The docking hardware 14 may be configured to interact with a wide variety of satellites 15 or other objects above the surface of the Earth. In general, the docking hardware 14 comprises any reusable or multiple-use means which is adapted to engage a payload launch vehicle interface, or to otherwise engage an object in space. Unlike some previous equipment designed for launch into orbit, the present invention includes a grasping means 14 which is not permanently affixed or connected to a payload.

A radiator 16 is disposed generally perpendicular to the boom 11 near the ion thrusters 12. The radiator 16, which conveys a coolant through manifold 17 and fluid flow tubes 18, dissipates heat from an energy converter out to space. The energy converter is powered by a nuclear reactor 19. The radiator 16 is generally situated between the grasping device 15 and the reactor 19. In general, the radiator 16 is a pumped fluid loop. An alternative embodiment comprises a capillary pump loop and/or heat pipes. In another alternative embodiment of the invention, the radiator 16 may be disposed along the boom 11, or a single combined radiator/boom means may be employed.

The reactor 19 generates heat through the controlled fission of nuclear fuel. This heat is then converted to electrical power. In a preferred embodiment, the reactor 19 is gas-cooled. In alternative embodiments, the reactor 19 employs a liquid-metal coolant, or some other working fluid or hat pipes. The reactor 19 is coupled to a radiation shield 20, which protects the object, payload or satellite 15 from radiation generated by the reactor 19. In one embodiment of the invention, the radiator 16 is configured to remain entirely within the protective zone of the radiation shield 20. In one embodiment, the radiation shield 20 incorporates multiple zone shielding to minimize mass. In another embodiment, the radiation shield includes a recuperator that is also employed as a gamma shield.

In a preferred embodiment of the invention, from 250 kW to 500 kW of sustained electrical power may be generated aboard an IOSTAR™, which vastly exceeds the sustained power generating capabilities of any prior satellite or spacecraft. This power generation capacity is huge when compared to the power levels of conventional satellites and spacecraft, which typically operate with less than 20 kW of power. This immense on-orbit power generating capacity enables the IOSTAR™ to conduct missions which are not feasible using conventional satellites. These missions include, but are not limited to, satellite inspection, monitoring, rescue, retrieval, repair, servicing and repositioning; direct communication services and in-orbit power generation for other spacecraft like the International Space Station.

The reactor 19 is also coupled to an energy converter 22 which converts heat to electrical energy. In one embodiment, the energy converter 22 includes a turbine driven by fluid that is heated by the reactor 19 to produce a large amount of electrical power. The converter 22 is coupled to the boom 11, next to the radiation shield 20. An energy converter may be an direct converter, which converts heat directly to electricity. As an alternative, an energy converter may be an indirect converter, which converts thermal energy to mechanical energy, and then to electrical energy.

In a preferred embodiment of the invention, the converter employs the Brayton Cycle. In alternative embodiments, the converter may be a Rankine or Stirling Cycle converter. A thermoelectric or thermionic converter may also be employed. In a preferred embodiment of the invention, a recuperator may be connected to the energy converter.

II. Details of IOSTAR™ Embodiments

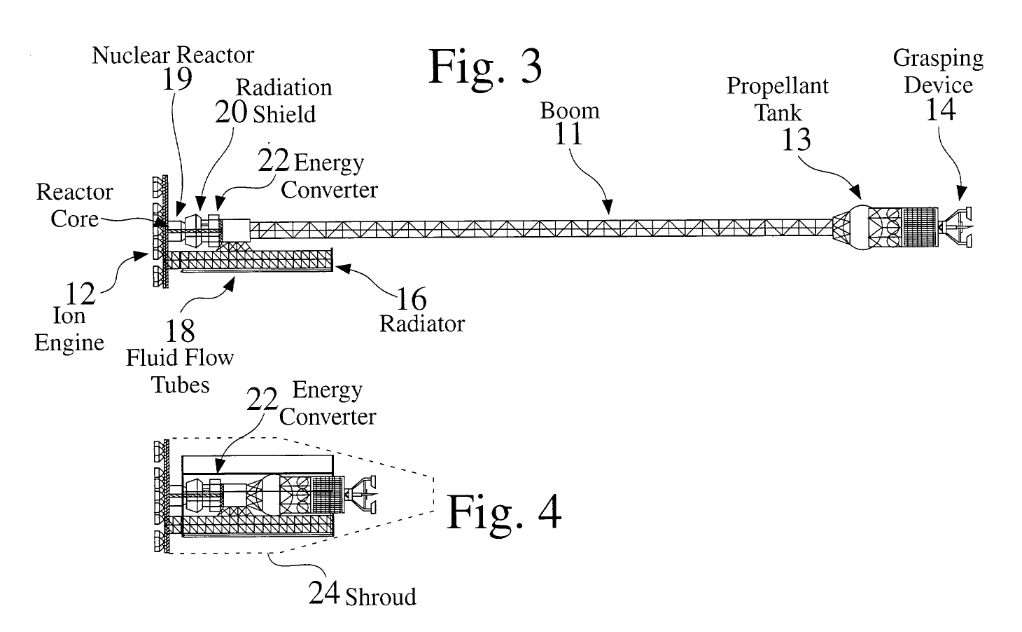

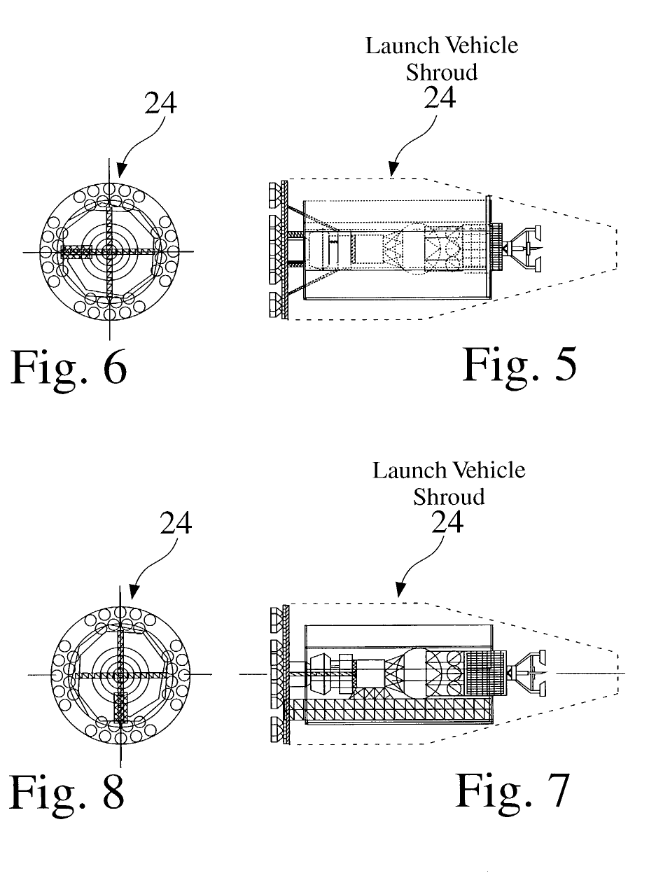

FIG. 3 provides a side view, where the IOSTAR™ is viewed along its side in the plane of the radiator panels 16. FIG. 4 offers a view of the invention in its fully collapsed configuration, capable of being stowed in a launch vehicle shroud 24.

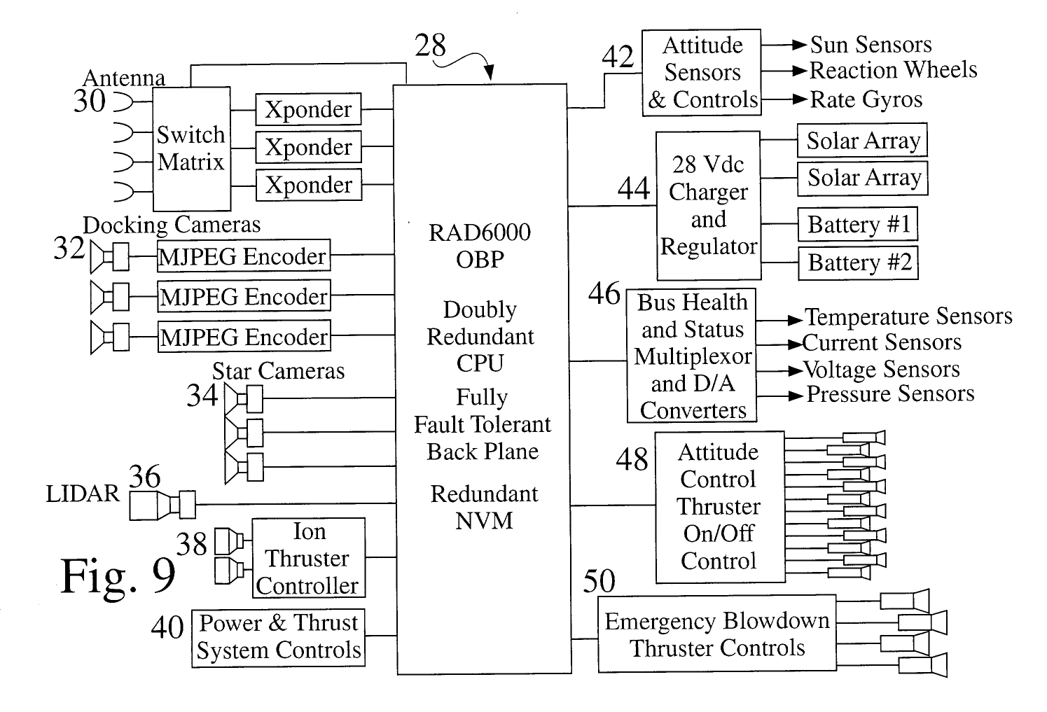

FIGS. 5, 6, 7 and 8 present more detailed end and cross-sectional views of the IOSTAR™ stowed in the launch vehicle shroud 24. In one preferred embodiment of the invention, the IOSTAR™ is placed in orbit using the United States Space Shuttle.

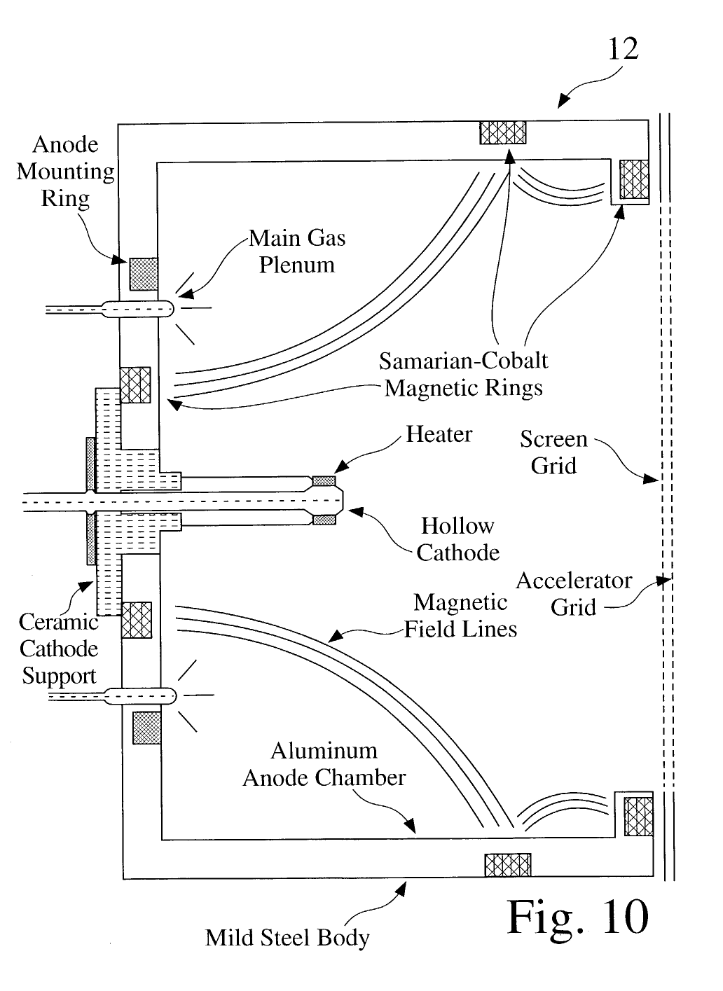

FIG. 9 supplies a schematic block diagram of control systems 28 designed for a preferred embodiment of the invention. A doubly redundant set of CPUs manage the many subsystems aboard the IOSTAR™, including antennas 30, docking and star cameras 32, 34, RADAR and LIDAR systems 36 for tracking objects or satellites 15, an ion thruster controller 38, and power and thrust system controls 40. These systems enable the present invention to rendezvous and dock with a satellite or object in orbit. In an alternative embodiment, the various sensors and cameras aboard the IOSTAR™ may be used to conduct remote sensing missions. The block diagram also relates the CPUs to attitude sensors and controls 42, the 28VDC power system 44, the bus health and attitude control subsystems 46, 48 and an emergency blowdown thruster control 50.

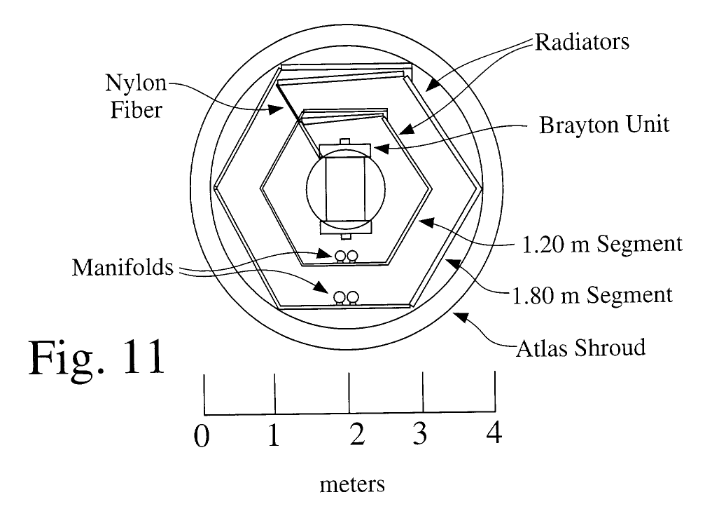

FIG. 10 offers a detailed schematic view of the ion propulsion system 12. A mixture of helium and xenon flows from tank 13 to the ion engine 12, where ions are created by a hollow cathode and accelerated through a series of grids to provide thrust for the IOSTAR™ spacecraft.

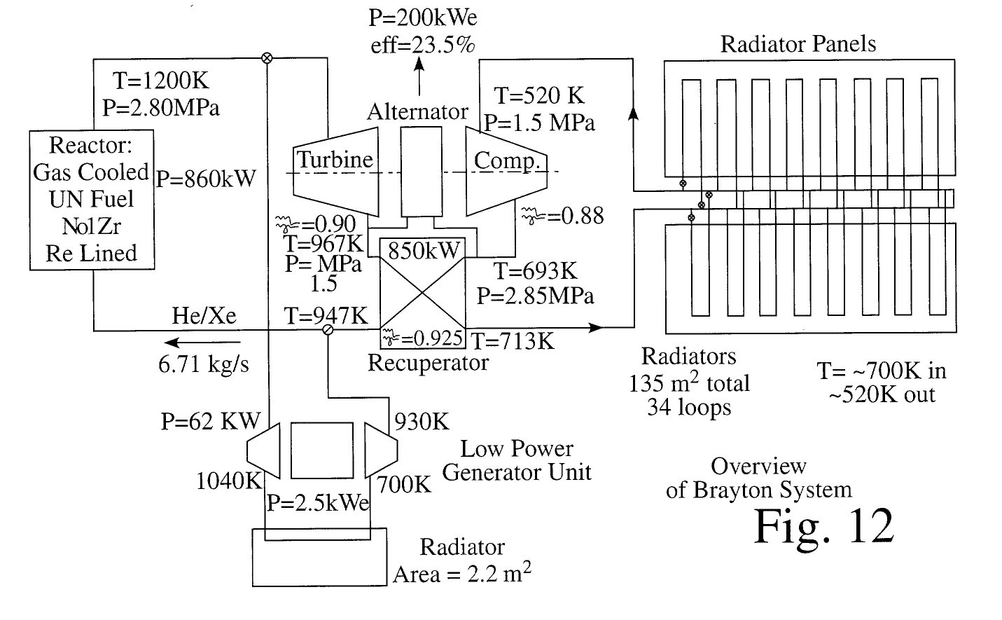

FIG. 11 reveals a cross-sectional view of one embodiment of the invention, depicting the launch vehicle shroud 24, radiators 16, manifolds 17 and energy converter 22.

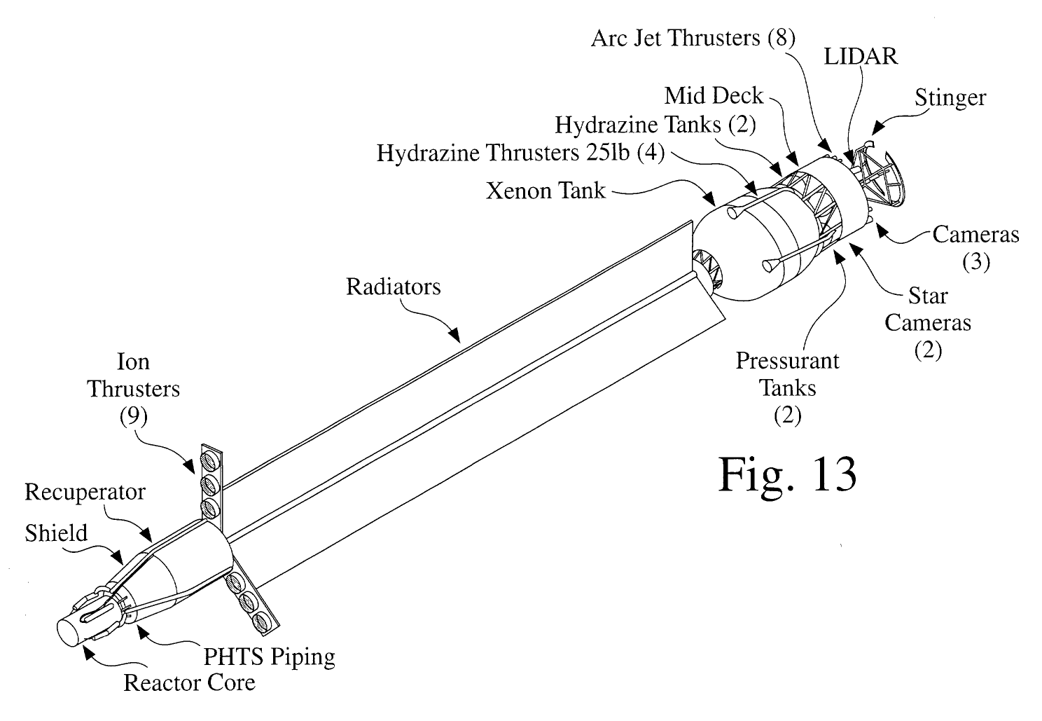

FIG. 12 supplies a schematic diagram which offers an overview of the Brayton System, the energy converter 22 that is utilized in a preferred embodiment of the invention. Heat from the reactor 19 drives a turbine, which, in turn, drives an alternator and a compressor. A recuperator increases the efficiency of the system by recovering a portion of the heat from the turbine exhaust to pre-heat the working fluid. Radiators 16 expel waste heat to outer space.

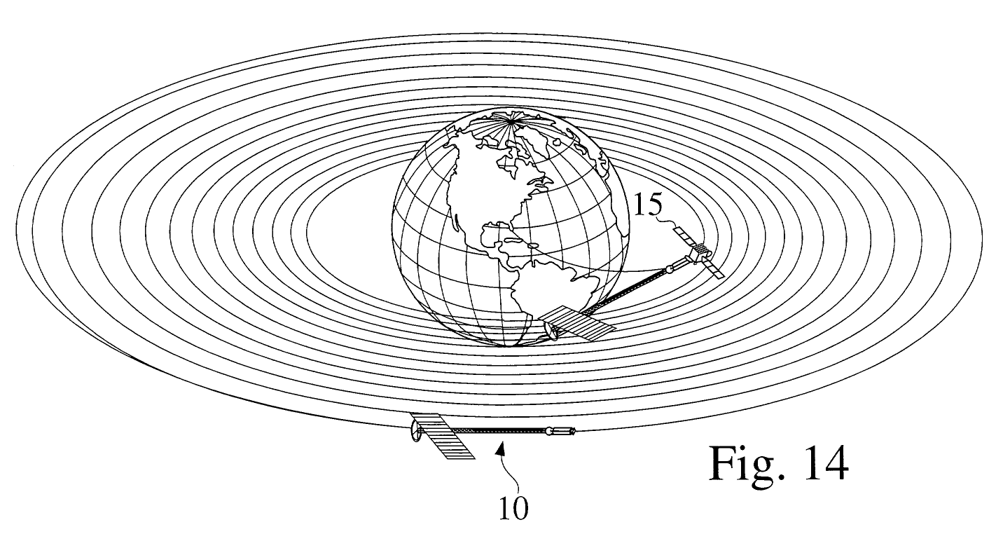

FIG. 13 provides a view of an alternative embodiment of the IOSTAR™ which includes radiators disposed along the boom.

III. IOSTAR™ Missions & Operations.

The present invention is different from conventional orbital systems, in that it will be capable of accomplishing many missions over a long life. Although the IOSTAR™ will be reusable, the entire system will be capable of being launched using a single launch vehicle, preferably the United States Space Shuttle. Other launch vehicles that are reusable or expendable may also be employed.

The first implementation of the IOSTAR™ will be constructed entirely on the Earth's surface, and then will be launched into orbit. Later implementations may be partially or completely constructed in orbit. In general, the IOSTAR™ may be controlled from a terrestrial operations center, or may operated by an on-orbit controller.

In general, the invention is fully extended after launch, and is then ready for operations. A first, general mission will comprise locating a satellite already in orbit, and then grasping, moving and releasing that satellite. IOSTAR™ will be able to move spacecraft between low Earth orbits and positions in higher orbits or to other locations in our Solar System. This primary mission of moving an object in space includes transporting satellites from one position in an orbit to another, from one orbit to another, to distant locations beyond Earth orbit or from distant locations beyond Earth orbit back to Earth orbit. The IOSTAR™ may be used for missions to the Moon, to the Planets or to the asteroids. Another mission may include changing the position of a satellite so that it is purposefully de-orbited.

In general, the term “rendezvous” pertains to the approach of an IOSTAR™ to another object or objects in space. Rendezvous may or may include station-keeping, or any contact, probing, interaction, coupling, observing or docking between an IOSTAR™ and another object.

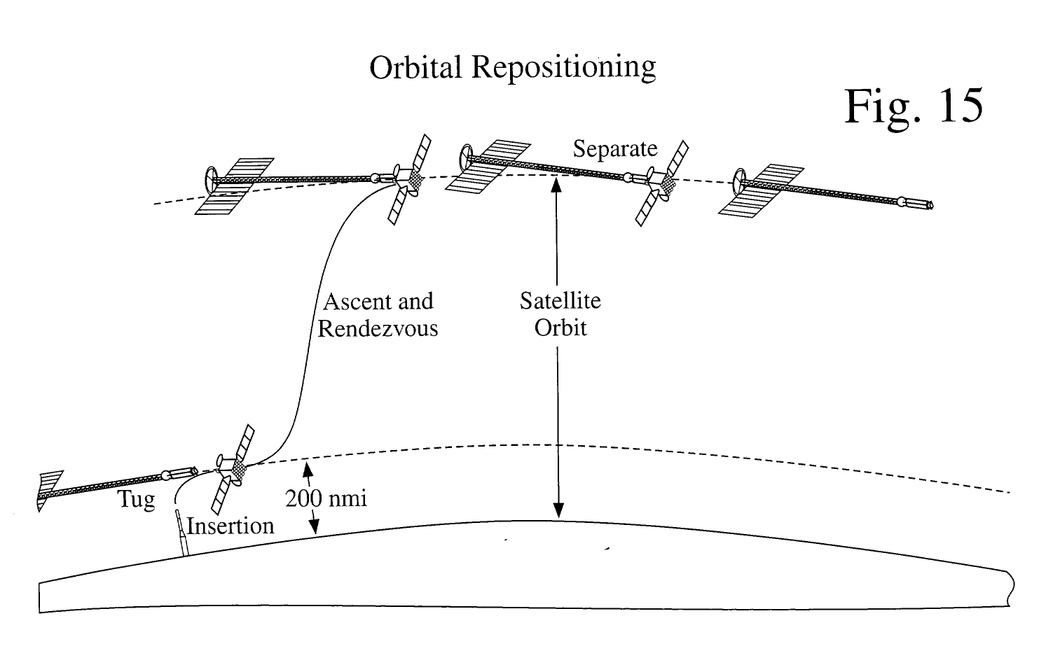

Once the IOSTAR™ completes its rendezvous and docking with a satellite, the satellite may be transported for retrieval and/or repair. In general, the repositioning of a satellite from one location to another will involve moving the satellite along an incremental, expanding, generally spiral pathway. FIG. 14 illustrates one of the basic methods of the invention. A satellite 15 is first launched using a conventional booster to a low Earth orbit of roughly 150 nautical miles. The IOSTAR™ 10 then completes a rendezvous with the satellite 15, and engages the satellite 15 with its docking hardware 14. The IOSTAR™ then gradually raises the altitude of the satellite 15 to an operational orbit by moving the payload along an incremental, expanding spiral pathway. This procedure provides substantial cost savings for delivering a spacecraft to an operational orbit compared to the conventional technique of launching spacecraft with a multi-stage rocket. In an alternative embodiment of the invention, the IOSTAR™ will be able to rendezvous with an object beyond Earth orbit. In this embodiment, the IOSTAR™ will be capable of retrieving an object or spacecraft from a remote location beyond Earth orbit.

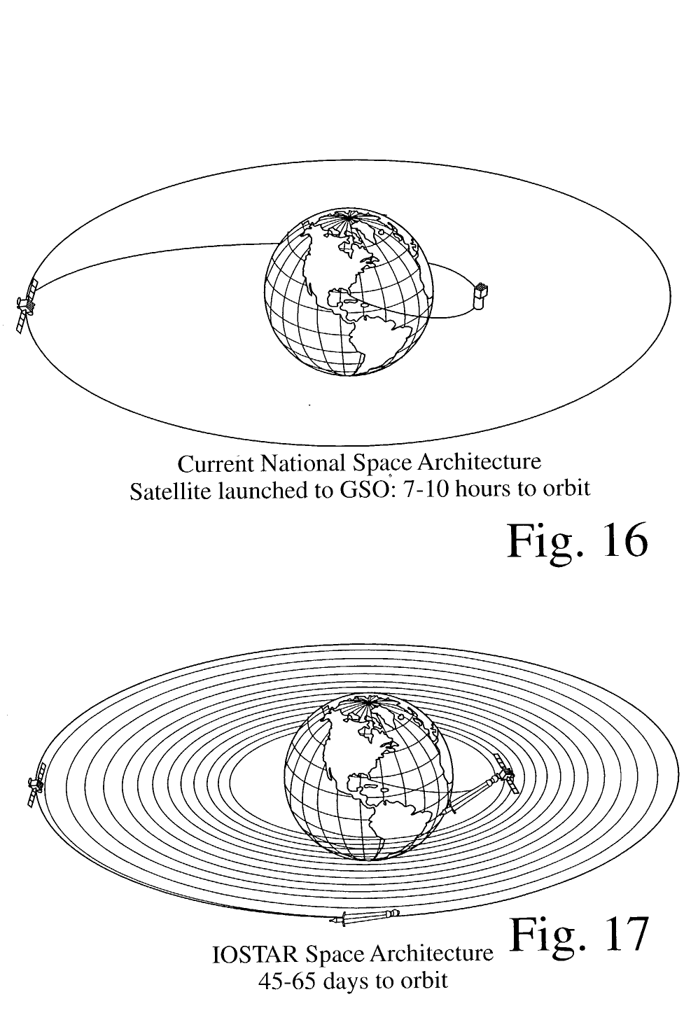

FIG. 15 depicts an orbital repositioning mission. The invention may not only be used to transport a new satellite to its destination orbit, but may also be employed to capture a satellite which has reached the end of its useful life and needs to be safely de-orbited or placed in a disposal orbit.

In general, the primary IOSTAR™ mission will involve rendezvousing and docking with a spacecraft which is already in a low Earth orbit. After docking, the IOSTAR™ will then move from a low Earth orbit to a high Earth orbit or to a position beyond Earth orbit. As an alternative, the IOSTAR™ will first travel to a high orbit or to a position beyond Earth orbit, locate and grasp an object, and then relocate it to Earth orbit or to a different position beyond Earth orbit.

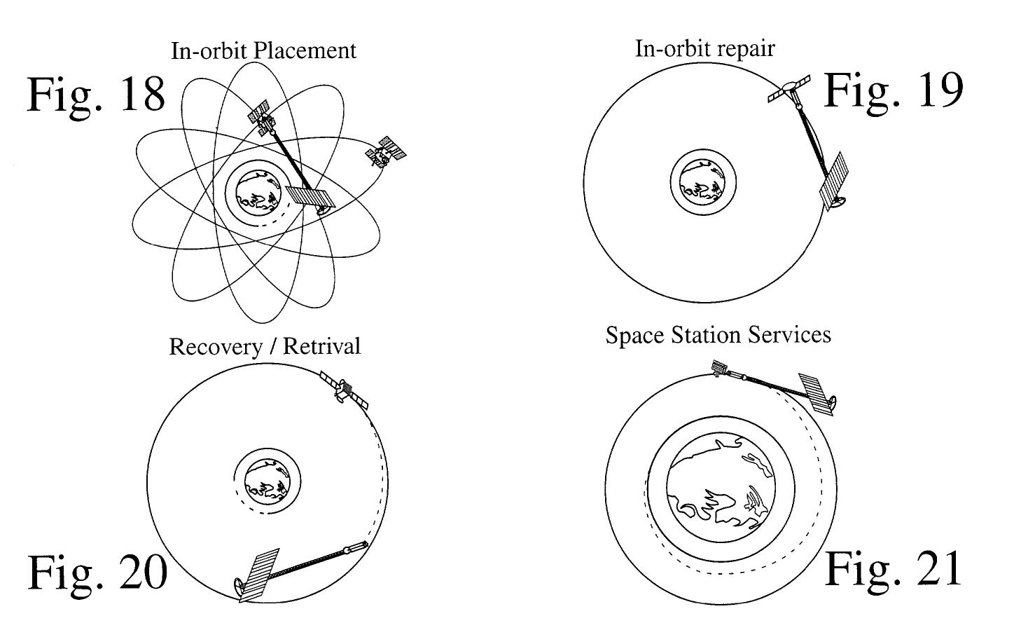

FIGS. 16 & 17 compare a conventional geosynchronous mission to an IOSTAR™ mission. In a conventional launch, a satellite reaches high orbit in seven to ten hours, but at great expense. Using IOSTAR™, the satellite takes a gradual spiral path over a 45 to 65 day period to reach high orbit, but at a much lower cost.

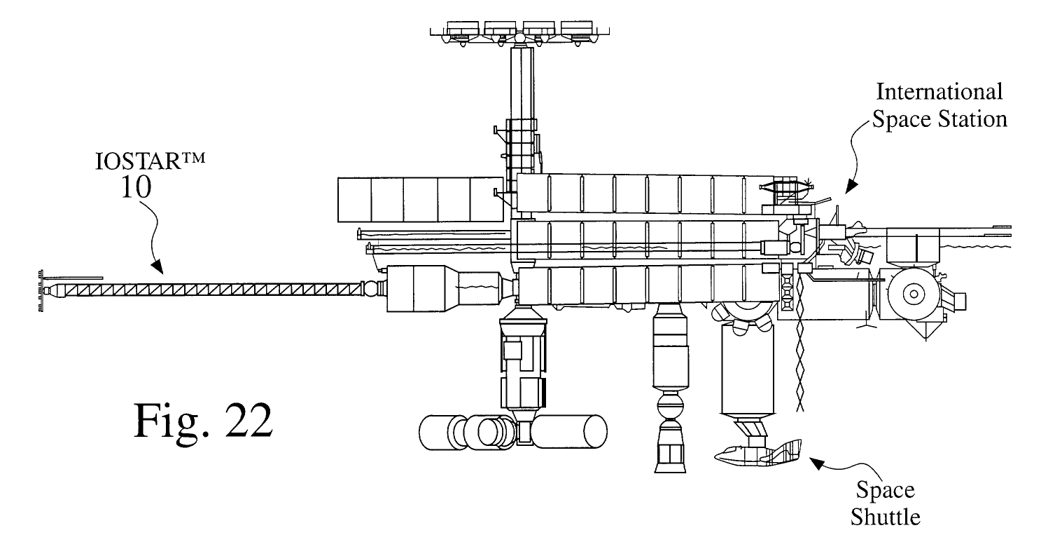

FIGS. 18, 19, 20 and 21 furnish generalized views of four representative IOSTAR™ missions, including in-orbit placement, in-orbit repair, recovery and retrieval and Space Station Servicing. While all the IOSTAR™ objectives and missions are too numerous to delineate in this Specification, Table Three provides a representative and illustrative list of uses for the present invention in outline form.

TABLE THREE
Objectives & Missions

Correct an anomalous satellite Earth orbit
Provide mobility for an object in orbit
Move object in space from one geostationary orbital position to another
Move object in space from one geosynchronous orbital position to another
Inspect object in orbit
Repair an object in orbit
Extend useful life of a satellite
By replenishing a consumable
By replenishing power
By replenishing fuel
By replacing a battery
By replacing a satellite component
Reposition satellite from a high to low orbit
Service satellite in combination with the U.S. Space Shuttle
Service satellite in combination with the International Space Station
Reposition satellite from a low to a high orbit to realize cost savings
compared to the costs of a conventional launch
Move a satellite into a disposal orbit
Provide services to an insurer
Salvage a satellite in accordance with an insurance contract
Enable an insurer to lower launch premiums
Obtain information about a failure of an orbiting asset
Enable an insurer to lower the financial risks of a satellite launch
Maintain a fleet of operating satellites, including United States Global
Positioning Satellites
Supply on-orbit power to another spacecraft
Move spare satellite from one orbital altitude or plane to another
Provide services to a satellite manufacturer
Provide services to a satellite user
Provide services to a government agency
Use IOSTAR ™ as a reusable upper stage of a conventional launch
vehicle to reduce launch costs
Use IOSTAR ™ and a laser used for orbital debris removal
Use laser to divert an asteroid
Produce propellant from an asteroid
Produce propellant from water launched into orbit from Earth
Produce propellant from a stable, storable material launched into orbit
from Earth
Process ice present on an asteroid by electrolysis to form hydrogen and
oxygen
Process carbonaceous material present on an asteroid to form a storable
propellant Recycle objects in space

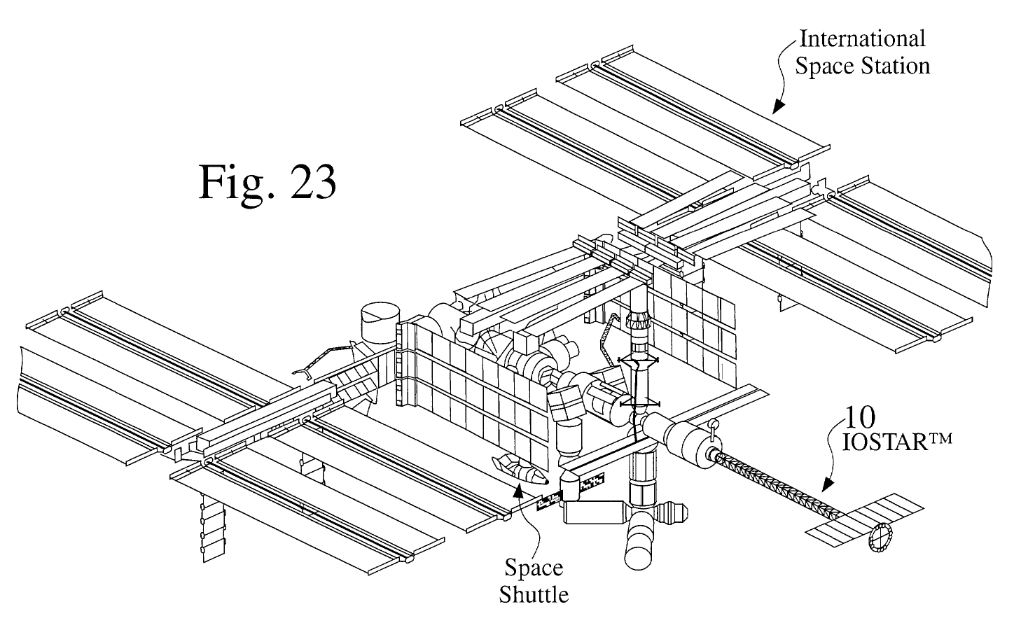

FIGS. 22 and 23 portray the IOSTAR™ in combination with the International Space Station.

One embodiment of the invention will be configured to provide direct communication services that include any one or two-way transmissions or emanations between or among the IOSTAR™ and terminals on or near the Earth's surface, or with other satellites or spacecraft in orbit. One example of a conventional direct communication service is a high-bandwidth transmission to consumers like DirecTV™.

In general, these direct communication services will be conducted using electromagnetic, optical or any other suitable frequencies or modes of communication over a distance. In one embodiment of the invention, IOSTAR's direct communication services will be conducted using frequency bands 11 and 12. Frequency band 11 extends from 30 to 300 GigaHertz, and is also referred to by the term “millimetric waves.” Frequency band 12 extends from 300 to 3000 GigaHertz or 3 TeraHertz, and is also referred to by the term decimillimetric waves. This nomenclature of frequency bands was adopted in the Radio Regulations of the International Telecommunication Union, Article 2, Section 11, Geneva; 1959.

These direct communication services will generally be enabled by IOSTAR's enormous power generating capabilities. FIG. 8 is a perspective view of an alternative embodiment of the invention, the IOSTAR™ Direct Broadcast System 26. Since the IOSTAR™ can generate very high levels of electrical power compared to conventional satellites 15, it may be used to transmit direct broadcast signals at extremely high frequencies. The Ku-Band (12-17 GHz) is the highest range of radio frequencies that are currently used by commercial satellites to communicate with customers on the ground. By drawing on its massive power supply, the IOSTAR™ Direct Broadcast System will be capable of offering regulated direct broadcast signals at frequencies of 100 GHz and beyond using a beam-forming array or a steerable antenna to penetrate layers of the atmosphere which absorb and scatter conventional, lower power signals. In general, the present invention is capable of generating a vast amount of electrical power to provide a wide variety of direct communication services that offer direct transmissions between the present invention and terrestrial terminals. In one embodiment of the invention, direct communication services are conducted using frequency bands 11 and 12. In general, these direct communication services may be provided by the present invention utilizing any means, mechanism or phenomenon that exploits particle or electromagnetic wave transmissions, forces, fields or action at a distance, including the radio-frequency and optical spectra.

### CONCLUSION

Although the present invention has been described in detail with reference to a particular preferred embodiment and alternative embodiments, persons possessing ordinary skill in the art to which this invention pertains will appreciate that various modifications and enhancements may be made without departing from the spirit and scope of the claims that follow. The various apparatus and methods that have been disclosed above are intended to educate the reader about preferred embodiments, and are not intended to constrain the limits of the invention or the scope of the claims. The List of Reference Characters which follows is intended to provide the reader with a convenient means of identifying elements of the invention in the Specification and Drawings. This list is not intended to delineate or narrow the scope of the claims.

LIST OF REFERENCE CHARACTERS

| | |
|---|---|
| 10 | In-Orbit Space Transportation & Rescue System, or IOSTAR ™ |
| 11 | Collapsible spacecraft boom |
| 12 | Electric propulsion system |
| 13 | Propellant tank |
| 14 | Grasping/Docking mechanism |
| 15 | Object, payload or satellite |
| 16 | Radiator |
| 17 | Manifold bellows |
| 18 | Gas flow tubes |
| 19 | Nuclear reactor |
| 20 | Radiation shield |
| 22 | Energy converter |
| 24 | Launch vehicle |
| 26 | IOSTAR ™ Direct Broadcast System |
| 28 | Block diagram of control systems |
| 30 | Antenna |
| 32 | Docking cameras |
| 34 | Star cameras |
| 36 | RADAR & LIDAR |
| 38 | Ion thruster controller |
| 40 | Power and thrust system controllers |
| 42 | Attitude sensors and controls |
| 44 | 28 VDC charger and regulator |
| 46 | Bus health and status multiplexer and D/A converters |
| 48 | Attitude control thruster on/off control |
| 50 | Emergency blowdown thruster control |

What is claimed is:

1. An apparatus comprising:
a boom means (11) for providing support;
a nuclear reactor means (19) for generating heat; said nuclear reactor means (19) being coupled to said boom means (11);
a payload protection means (20) for protecting a payload (15) from radiation; said payload protection means (20) being coupled to said nuclear reactor means (19);
a radiator means (16) for dissipating heat; said radiator means (16) being coupled to said nuclear reactor means (19);
an electric propulsion means (12) for supplying thrust; said electric propulsion means (12) being coupled to said nuclear reactor means (19);
a replenishable tank means (13) for storing fuel for said electric propulsion means (12); said replenishable tank means (13) being coupled to said boom means (11); and
a multiple-use grasping means (14) for engaging an object above the surface of the Earth; said grasping means (14) being coupled to said boom means (11).

2. An apparatus as recited in claim 1, in which said boom means (11) is a partially foldable frame which may be collapsed to fit within a launch vehicle.

3. An apparatus as recited in claim 1, which may be launched into orbit using a single launch vehicle.

4. An apparatus as recited in claim 1, in which said boom means (11) can be folded into a launch vehicle, and then be deployed in its fully extended position after launch.

5. An apparatus as recited in claim 4, in which said launch vehicle is expendible.

6. An apparatus as recited in claim 4, in which said launch vehicle is reusable.

7. An apparatus as recited in claim 4, in which said reusable launch vehicle is a United States Space Shuttle.

8. An apparatus as recited in claim 1, in which said boom means (11) also functions as a radiator means (16).

9. An apparatus as recited in claim 1, in which said radiator means (16) also provides structural support and takes the place of said boom means (11).

10. An apparatus as recited in claim 1, which is able to perform autonomous position and attitude control.

11. An apparatus as recited in claim 1, in which said object is a satellite (15).

12. An apparatus as recited in claim 1, further including a RADAR unit.

13. An apparatus as recited in claim 1, further including a LIDAR unit.

14. An apparatus as recited in claim 1, which is capable of rendezvous with a satellite (15) in orbit.

15. An apparatus as recited in claim 1, which is capable of rendezvous with an object beyond Earth orbit.

16. An apparatus as recited in claim 1, including an on-board sensor for performing a satellite rendezvous.

17. An apparatus as recited in claim 1, including an on-board sensor for performing remote sensing.

18. An apparatus as recited in claim 1, including an on-board camera for performing a satellite rendezvous.

19. An apparatus as recited in claim 1, which is capable of docking with a satellite in orbit.

20. An apparatus as recited in claim 1, which is capable of docking with an object beyond Earth orbit.

21. An apparatus as recited in claim 1, including on-board sensor for performing a satellite docking maneuver.

22. An apparatus as recited in claim 1, including an on-board camera for performing a satellite docking maneuver.

23. An apparatus as recited in claim 1, in which said multiple-use grasping means (14) is not permanently affixed to a payload.

24. An apparatus as recited in claim 1, in which said nuclear reactor means (19) includes an energy converter.

25. An apparatus as recited in claim 24, in which said energy converter is a direct energy converter.

26. An apparatus as recited in claim 24, in which said energy converter is an indirect energy converter.

27. An apparatus as recited in claim 24, in which said energy converter is a thermoelectric converter.

28. An apparatus as recited in claim 24, in which said energy converter is a Brayton Cycle converter.

29. An apparatus as recited in claim 24, in which said energy converter is a Rankine Cycle converter.

30. An apparatus as recited in claim 24, in which said energy converter is a Stirling Cycle converter.

31. An apparatus as recited in claim 1, in which said nuclear reactor means (19) is gas cooled.

32. An apparatus as recited in claim 1, which is cooled by a liquid-metal.

33. An apparatus as recited in claim 1, in which said radiation shield means (20) incorporates multiple zone shielding to minimize mass.

34. An apparatus as recited in claim 1, in which said radiation shield means (20) includes a recuperator.

35. An apparatus as recited in claim 1, in which said recuperator is employed as a gamma shield.

36. An apparatus as recited in claim 1, further including a shield to provide protection from impact with an object in space.

37. An apparatus as recited in claim 1, in which said radiator means (16) is a pumped fluid loop.

38. An apparatus as recited in claim 1, in which said electric propulsion (12) means is an ion propulsion system.

39. An apparatus as recited in claim 1, in which said ion propulsion system (12) emits xenon ions.

40. An apparatus as recited in claim 1, in which said ion propulsion system (12) includes a Hall thruster.

41. An apparatus as recited in claim 1, in which said replenishable tank means (13) may be refilled using a separate service vehicle.

42. An apparatus as recited in claim 1, in which said replenishable tank means (13) can be refilled in a relatively low gravity environment.

43. An apparatus as recited in claim 1, in which said replenishable tank means (13) may be filled with multiple propellants.

44. An apparatus as recited in claim 1, which may be controlled from a terrestrial operations center.

45. An apparatus as recited in claim 1, which may be controlled from an on-orbit controller.

46. An apparatus as recited in claim 1, which is partially constructed on Earth.

47. An apparatus as recited in claim 1, which is completely constructed on Earth.

48. An apparatus as recited in claim 1, which is partially constructed in orbit.

49. An apparatus as recited in claim 1, in which said multiple-use grasping means (14) may grasp a payload after launch.

50. An apparatus as recited in claim 1, in which said multiple-use grasping means (14) may release a payload after launch.

51. An apparatus as recited in claim 1, in which said multiple-use grasping means (14) is adapted to seize a satellite (15) in Earth orbit so it may be transported to a different orbit.

52. An apparatus as recited in claim 1, in which said multiple-use grasping means (14) is adapted to seize a satellite (15) in Earth orbit to transport said satellite (15) to a different position.

53. An apparatus as recited in claim 1, in which said grasping means (14) is adapted to seize a spacecraft in Earth orbit to transport said spacecraft to the Moon.

54. An apparatus as recited in claim 1, in which said grasping means (14) is adapted to engage a payload launch vehicle interface.

55. An apparatus as recited in claim 1, in which said grasping means (14) is adapted to seize a spacecraft in Earth orbit to transport said spacecraft to another Planet in our Solar System.

56. An apparatus as recited in claim 1, in which said grasping means (14) is adapted to seize a satellite (15) in Earth orbits so it may be de-orbited.

57. An apparatus as recited in claim 1, in which said grasping means (14) is adapted to seize a satellite (15) in Earth orbits so it may be transported for retrieval and repair.

58. An apparatus as recited in claim 1, in which said satellite (15) is placed in an operational orbit by moving along an incremental, expanding, generally spiral pathway.

59. An apparatus as recited in claim 1, which is positioned in orbit to provide a direct communication service.

60. An apparatus as recited in claim 59, in which said direct communication service is conducted using frequency bands 11 and 12.

61. An apparatus as recited in claim 59, in which said direct communication service is conducted using electromagnetic frequencies.

62. An apparatus as recited in claim 59, in which said direct communication service is conducted using optical frequencies.

63. An apparatus as recited in claim 59, in which said high frequency communication service is conducted at extremely high output power compared to conventional satellite operations.

64. An apparatus as recited in claim 1, which is used to correct an anomalous satellite Earth orbit.

65. An apparatus as recited in claim 1, which is used to provide mobility for an object in orbit.

66. An apparatus as recited in claim 65, in which said object is moved from one geosynchronous orbital position to another.

67. An apparatus as recited in claim 1, which is used for inspection of an object in orbit.

68. An apparatus as recited in claim 1, which is used to repair an object in orbit.

69. An apparatus as recited in claim 1, which is used to extend the useful life of a satellite.

70. An apparatus as recited in claim 1, which is used to extend the useful life of a satellite by replenishing a consumable.

71. An apparatus as recited in claim 1, which is used to extend the useful life of a satellite by replenishing power.

72. An apparatus as recited in claim 1, which is used to extend the useful life of a satellite by replenishing fuel.

73. An apparatus as recited in claim 1, which is used to extend the useful life of a satellite by replacing a battery.

74. An apparatus as recited in claim 1, which is used to extend the useful life of a satellite by replacing a satellite component.

75. An apparatus as recited in claim 1, which is used to reposition a satellite from a high to low orbit.

76. An apparatus as recited in claim 75, in which said satellite is then serviced in combination with the U.S. Space Shuttle.

77. An apparatus as recited in claim 75, in which said satellite is then serviced in combination with the International Space Station.

78. An apparatus as recited in claim 1, which is used to reposition a satellite from a low to a high orbit to realize cost savings compared to the costs of a conventional launch.

79. An apparatus as recited in claim 1, which is used to move a satellite into a disposal orbit.

80. An apparatus as recited in claim 1, which is used to provide services to an insurer.

81. An apparatus as recited in claim 80, which is used to salvage a satellite in accordance with an insurance contract.

82. An apparatus as recited in claim 80, which enables an insurer to lower launch premiums.

83. An apparatus as recited in claim 80, which is used to obtain information about a failure of an orbiting asset.

84. An apparatus as recited in claim 80, which enables an insurer to lower the financial risks of a satellite launch.

85. An apparatus as recited in claim 1, which is used to maintain a fleet of operating satellites.

86. An apparatus as recited in claim 85, in which said fleet of operating satellites includes the United States Global Positioning Satellites.

87. An apparatus as recited in claim 1, which is used to supply on-orbit power to another spacecraft.

88. An apparatus as recited in claim 1, which is used to move a spare satellite from one orbital altitude to another.

89. An apparatus as recited in claim 1, which is used to provide services to a satellite manufacturer.

90. An apparatus as recited in claim 1, which is used to provide services to a satellite user.

91. An apparatus as recited in claim 1, which is used to provide services to a government agency.

92. An apparatus as recited in claim 1, which is used as a reusable upper stage of a conventional launch vehicle to reduce launch costs.

93. An apparatus as recited in claim 1, further comprising a laser used for orbital debris removal.

94. An apparatus as recited in claim 1, further comprising a laser used for moving orbital debris.

95. An apparatus as recited in claim 1, which is used to produce propellant from an asteroid.

96. An apparatus as recited in claim 1, in which a propellant is produced from water launched into orbit from Earth.

97. An apparatus as recited in claim 1, in which a propellant is produced from a stable, storable material launched into orbit from Earth.

98. An apparatus as recited in claim 95, in which ice present on said asteroid is electrolyzed to form hydrogen and oxygen.

99. An apparatus as recited in claim 95, in which a carbonaceous material present on said asteroid is processed to form a storable propellant.

100. An apparatus as recited in claim 1, further comprising a recycling facility to recycle objects in space.

101. An apparatus as recited in claim 1, further comprising an on-board laser.

102. An apparatus as recited in claim 101, in which said on-board laser is used to divert an asteroid.

103. An apparatus as recited in claim 101, in which said on-board laser is used to divert an asteroid.

104. An apparatus comprising:
a collapsible boom (11); said boom being configured to collapse to fit within a launch vehicle and then expand once deployed in orbit;
a nuclear reactor (19) for generating heat; said nuclear reactor (19) being mounted at one end of said collapsible boom (11);
an energy converter coupled to said nuclear reactor (19) for generating electrical power;
a payload protection shield (20); said payload protection shield (20) being disposed between said payload and said nuclear reactor (19);
a radiator (16) for dissipating heat; said radiator (16) being connected to said energy converter (22);
an ion propulsion system (12); said ion propulsion system (12) being connected to said nuclear reactor (19);
a replenishable tank (13) for storing fuel for said ion propulsion system (12); said replenishable tank (13) being coupled to said collapsible boom (11); and
a multiple-use docking device (14) for engaging an object above the surface of the Earth.

105. A method comprising the steps of:
placing a first spacecraft in a low Earth orbit;
rendezvousing and docking with said first spacecraft in a low Earth orbit with a second spacecraft; said second spacecraft being reusable, in-orbit and having sufficient power to move from a low Earth orbit to a high Earth orbit; and
moving said docked first and second spacecraft to a high Earth orbit.

106. A method comprising the steps of:
placing a first spacecraft in a high Earth orbit;
rendezvousing and docking with said first spacecraft in a high Earth orbit with a second spacecraft; said second spacecraft being reusable, in-orbit and having sufficient power to move from a high Earth orbit to a low Earth orbit; and
moving said docked first and second spacecraft to a low Earth orbit.

107. A method comprising the steps of:
placing a first spacecraft in a position above the Earth;
rendezvousing and docking with said first spacecraft in a position above the Earth with a second spacecraft; said second spacecraft being reusable, in-orbit and being able to move from an Earth orbit to a position beyond Earth orbit; and
moving said docked first and second spacecraft to a position beyond Earth orbit.

108. A method comprising the steps of:
locating an object beyond Earth orbit;
rendezvousing with and grasping said object beyond Earth orbit with a second spacecraft; said second spacecraft being reusable, in-orbit and being able to move from a position beyond Earth orbit; and
moving both said object and second spacecraft to an Earth orbit.

109. A method of building an orbital facility comprising the steps of:
providing a boom means (11) for providing support;
adding a nuclear reactor means (19) for generating heat; said nuclear reactor means (19) being coupled to said boom means (11);
adding a payload protection means (20) for protecting a payload (15) from radiation; said payload protection means (20) being coupled to said nuclear reactor means (19);
adding a radiator means (16) for dissipating heat; said radiator means (16) being coupled to said nuclear reactor means (19);
adding an ion propulsion system (12) for supplying thrust; said ion propulsion system (12) being coupled to said nuclear reactor means (19);
adding a replenishable tank means (13) for storing propellant for said ion propulsion system (12); said replenishable tank means (13) being coupled to said boom means (11); and
adding a multiple-use grasping means (14) for engaging an object above the surface of the Earth; said grasping means (14) being coupled to said boom means (11).
